(19) United States
(12) Patent Application Publication
(10) Pub. No.: US 2016/0290607 A1
(43) Pub. Date: Oct. 6, 2016

(54) BACKLIGHT MODULE AND DISPLAY APPARATUS USING THE SAME

(71) Applicant: HON HAI PRECISION INDUSTRY CO., LTD., New Taipei (TW)

(72) Inventors: CHENG-WEI LEE, New Taipei (TW); HUNG-HSING LEE, New Taipei (TW)

(21) Appl. No.: 14/699,603

(22) Filed: Apr. 29, 2015

(30) Foreign Application Priority Data
Apr. 2, 2015 (TW) 104111040

(51) Int. Cl. F21V 19/00; G02F 1/1335

(52) U.S. Cl. CPC F21V 19/003; G02F 1/133603; G02F 1/133608; F21Y 2103/003

(57) ABSTRACT

A backlight module includes a substrate, at least one light bar coupled to the substrate, and at least one locating mechanism. The at least one locating mechanism is located on the substrate for locking the at least light bar to the substrate. The locating mechanism includes two first limiting portions, a plurality of second limiting portions, and a plurality of positioning poles. The second limiting portions and the positioning pole are alternately disposed between the opposite first limiting portions. The first limiting portion, the second limiting portion, and the positioning pole respectively limit the light bar in different directions.

This application claims priority to Taiwanese Patent Application No. 104111040 filed on Apr. 2, 2015, the contents of which are incorporated by reference herein.

### FIELD

The subject matter herein generally relates to backlight modules, and display apparatuses for locating a light bar.

### BACKGROUND

Display apparatuses include a rear panel and at least one light bar for emitting light. The light bar is located on a surface of the rear panel via screws.

### BRIEF DESCRIPTION OF THE FIGURES

Implementations of the present technology will now be described, by way of example only, with reference to the attached figures.

FIG. 1 is a schematic diagram of an embodiment of a display apparatus, the display apparatus includes an upper cover and a lower cover.

FIG. 2 is a partial, isometric view of a first embodiment of the display apparatus of FIG. 1, the display apparatus further includes a backlight module and a rear panel.

FIG. 3 is a partially exploded view of an embodiment of the display apparatus of FIG. 2 showing the backlight module disengaged from the rear panel.

FIG. 4 is an enlarged view of section IV-IV of an embodiment of the display apparatus of FIG. 3.

FIG. 5 is an enlarged view of section V-V of an embodiment of the display apparatus of FIG. 3.

FIG. 6 is a cross-sectional view taken along a line VI-VI of an embodiment of the display apparatus of FIG. 2.

FIG. 7 is partially exploded view of a second embodiment of the display apparatus of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a display apparatus 100 that can be easily assembled.

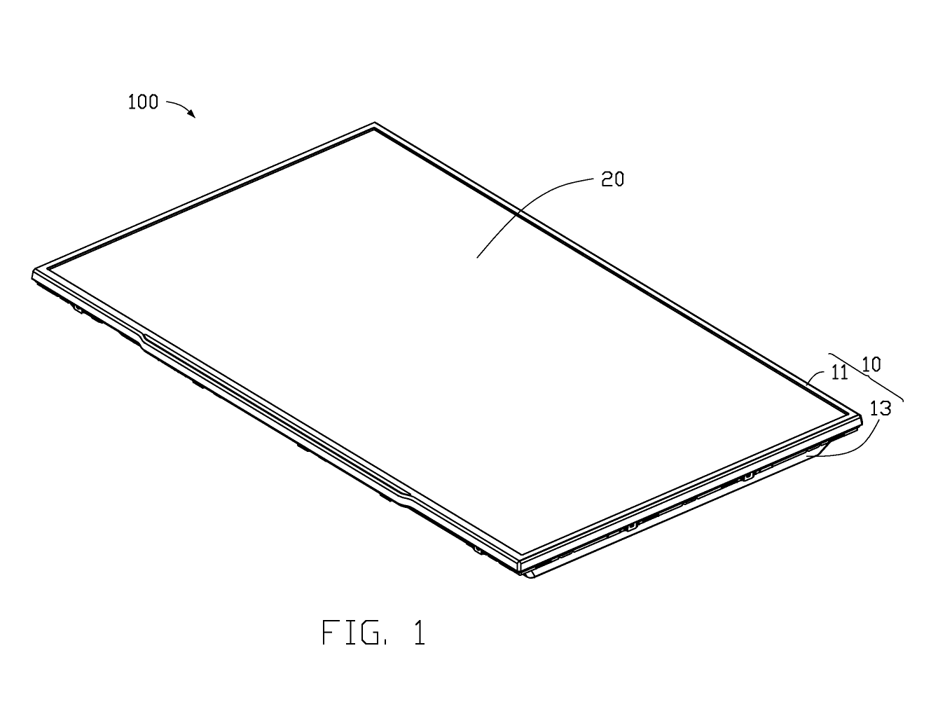

FIG. 1 illustrates an embodiment of a display apparatus 100 for displaying images. The display apparatus 100 is substantially rectangular shaped. In at least one embodiment, the display apparatus is a liquid crystal display (LCD) apparatus.

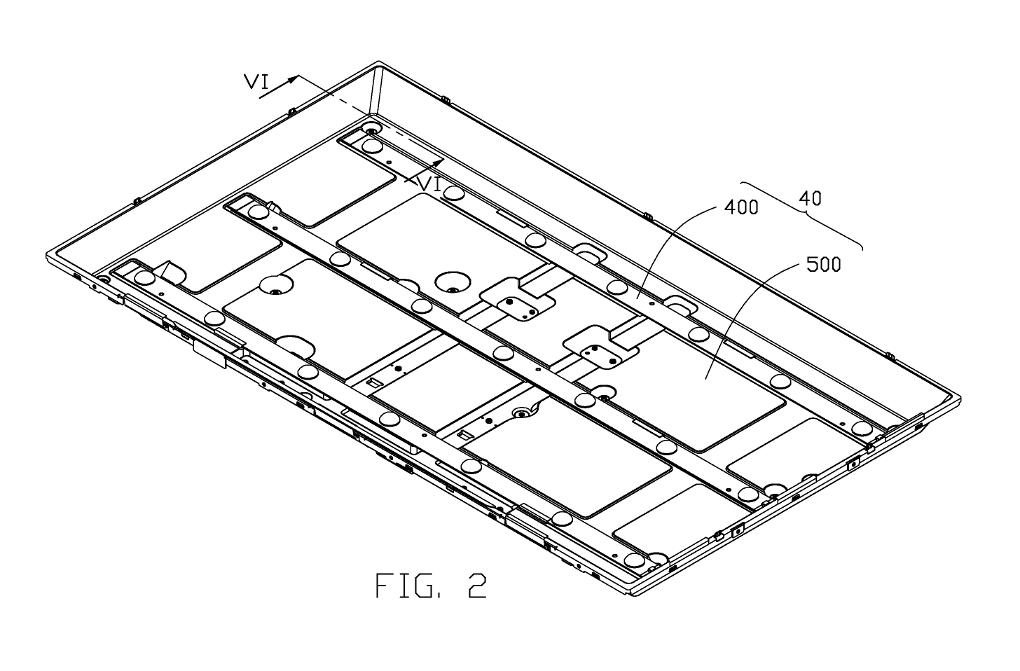

FIG. 2 illustrates an embodiment of the display apparatus 100. The display apparatus 100 includes a case 10, a display panel 20 for displaying images, and a backlight module 40 for providing backlight to the display panel 20.

The case 10 includes an upper cover 11 and a lower cover 13 cooperating with the upper cover 11 to define a receiving space. The display panel 20 and the backlight module 40 are received in the lower cover 13, and the backlight module 40 is adjacent to the lower cover 13. In at least one embodiment, the display apparatus 100 can further include a cover lens and touch module.

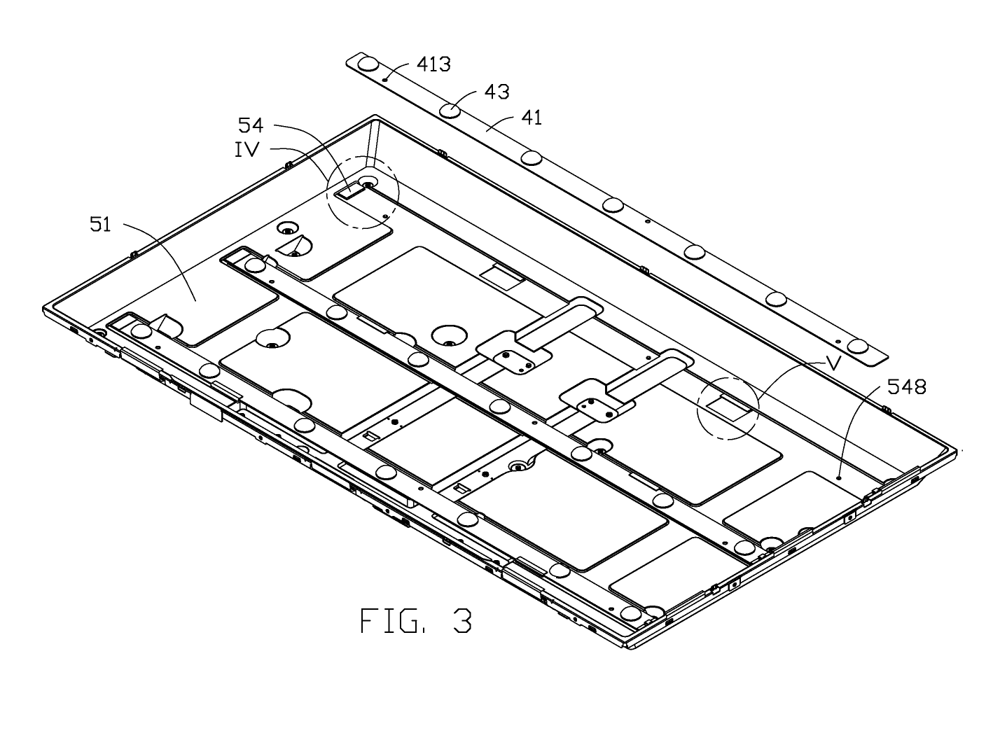

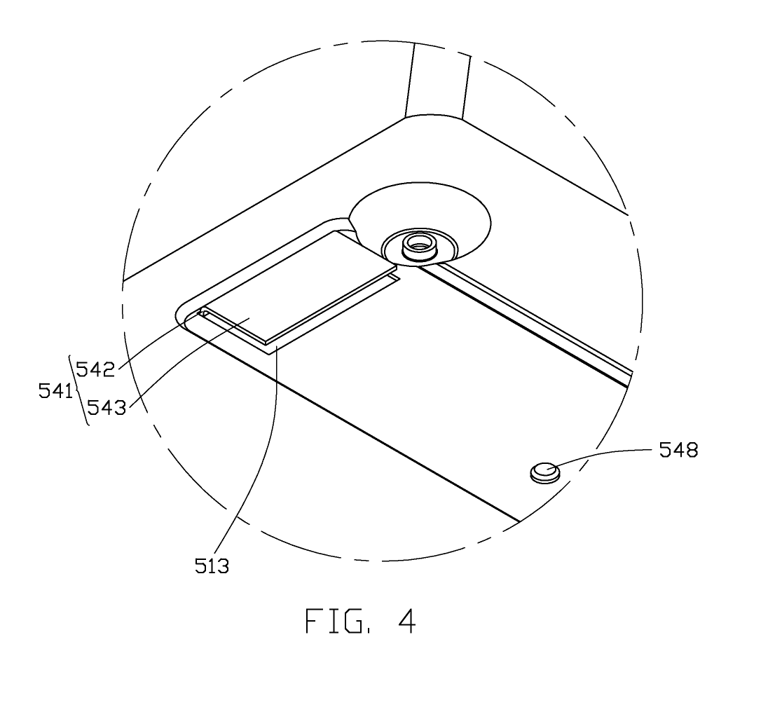

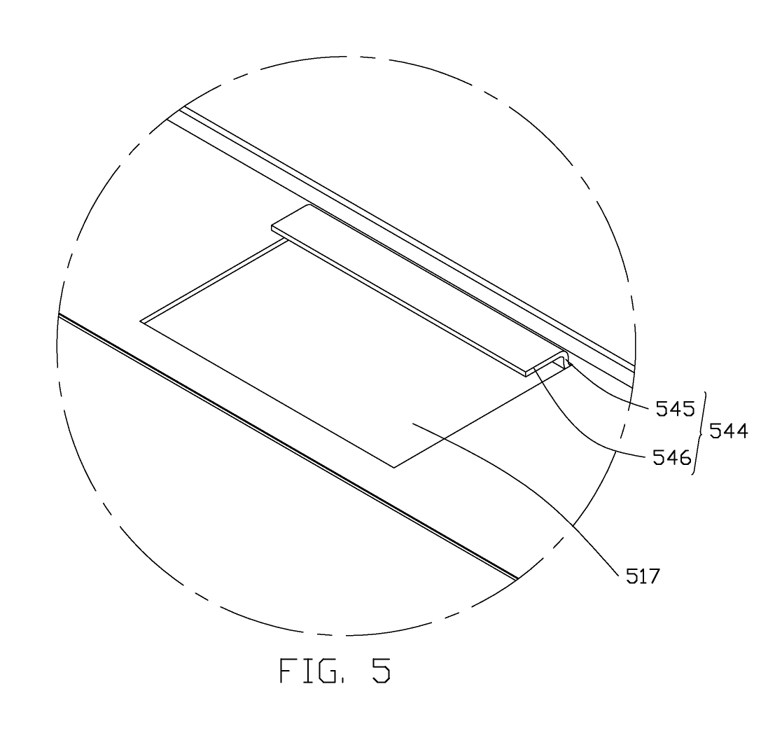

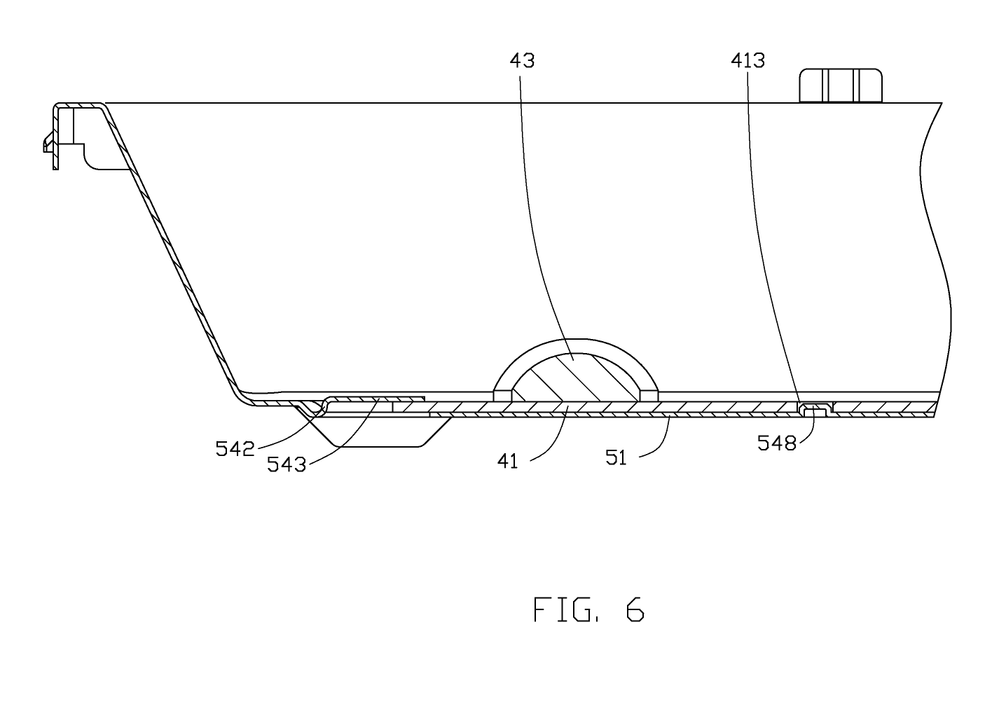

FIGS. 3-6 illustrate an embodiment of the backlight module 40. The backlight module 40 includes a plurality of light bars 400 parallel with each other and a rear panel 500. The light bar 400 is locked on the rear panel 500. In at least one embodiment, the light bar 400 provides light to the display panel 20. The backlight module 40 can further include a reflector, a light guide plate, and a plurality of optical films. In other embodiments, the lower cover 13 is a part of the rear panel 500.

The light bar 400 includes a printed circuit board (PCB) 41, and a plurality of light sources 43. The PCB 41 is substantially a rectangular plate. The PCB 41 provides a voltage to the light source 43. The PCB 41 defines a plurality of through holes 413. The through holes 413 cooperate with the rear panel 500 for locating a position of the light bar 400. The through holes 413 are staggered with each other.

The light sources 43 are spaced a predetermined distance from each other. The light source 43 is electrically connected to the PCB 41. In at least one embodiment, the light source 43 is light emitting diode (LED).

The rear panel 500 includes a substrate 51 and a locating mechanism 54 perpendicularly located on the substrate 51.

The substrate 51 is substantially rectangular plate. The substrate 51 defines a plurality of first openings 513 and a plurality of second openings 517. The first openings 513 are symmetrically disposed widthwise on opposite edges of the substrate 51. The second opening 517 is located between two opposite first openings 513. In at least one embodiment, the substrate 51 is made of metal material.

The locating mechanism 54 corresponds to the light bar 400, and is located at the position of the corresponding light bar 400 to prevent the light bar 400 from being moved. The locating mechanism 54 includes two opposite first limiting portions 541, a plurality of second limiting portions 544, and a plurality of positioning poles 548. The second limiting portions 544 and the positioning poles 548 are alternatively disposed between the opposite first limiting portions 541. The first limiting portion 541, the second limiting portion 544, and the positioning pole 548 respectively limit the light bar 400 in different directions.

The first limiting portion 541 limits the position of the light bar 400 in a first direction and a second direction perpendicular to the first direction. The first limiting portion 541 corresponds to the first opening 513. The first limiting portion 541 is substantially “L” shaped. The first limiting portion 541 includes a first connecting plate 542 and a first resisting plate 543.

The first connecting plate 542 is extended widthwise from an edge of the first opening 513 adjacent to the edge of the substrate 51. The first connecting plate 542 limits the position of the light bar 400 in the first direction to prevent the light bar 400 from being moved along the first direction. In at least one embodiment, the first connecting plate 542 and the substrate 51 define an acute angle. The first direction is parallel lengthwise with the light bar 400. In other embodiments, the first connecting plate 542 and the substrate 51 define a right angle. The first direction and the light bar 400 define a lengthwise angle.

The first resisting plate 543 limits the position of the light bar 400 in the second direction to prevent the light bar 400 from being moved along the second direction. The first resisting plate 543 is extended from an edge of the first connecting plate 542 away from the substrate 51. The first resisting plate 543 is parallel with the substrate 51. The first resisting plate 543 completely covers the first opening 513. In at least one embodiment, the second direction is perpendicular to the substrate 51.

The second limiting portion 544 limits the light bar 400 in the second direction and a third direction perpendicular to the second direction. The second limiting portion 544 corresponds to the second opening 517. The second limiting portion 544 is substantially “L” shaped. The second limiting portion 544 includes a second connecting plate 545 and a second resisting plate 546.

The second connecting plate 545 is extended lengthwise from an edge of the second opening 517 adjacent to the edge of the substrate 51. The second connecting plate 545 limits the position of the light bar 400 in the third direction to prevent the light bar 400 from being moved along the third direction. In at least one embodiment, the second connecting plate 545 and the substrate 51 define an acute angle. The third direction is parallel widthwise with the light bar 400. In other embodiments, the second connecting plate 545 and the substrate 51 define a right angle. The third direction and the light bar 400 define a lengthwise angle.

The second resisting plate 546 limits the position of the light bar 400 in the second direction to prevent the light bar 400 from being moved along the second direction. The second resisting plate 546 is extended from an edge of the second connecting plate 545 away from the substrate 51. The second resisting plate 546 is parallel with the substrate 51. The second resisting plate 543 partially covers the first opening 513.

The positioning poles 548 are perpendicularly disposed on the substrate 51 and are staggered with each other. The positioning poles 548 cooperate with the corresponding through holes 413 for limiting the light bar 400 on a plane parallel with the substrate 51. In at least embodiment, the positioning pole 548 is substantially cylinder shaped. In other embodiments, the positioning pole 548 is substantially a frustum of a cone shaped or polygon shaped.

In assembly, the light bar 400 is located below the first limiting portion 541 and the second limiting portion 544, and the positioning pole 548 is inserted into the corresponding through hole 413, thus the light bar 400 is locked on the substrate 51 and is prevented from being moved along the first, second, and third directions.

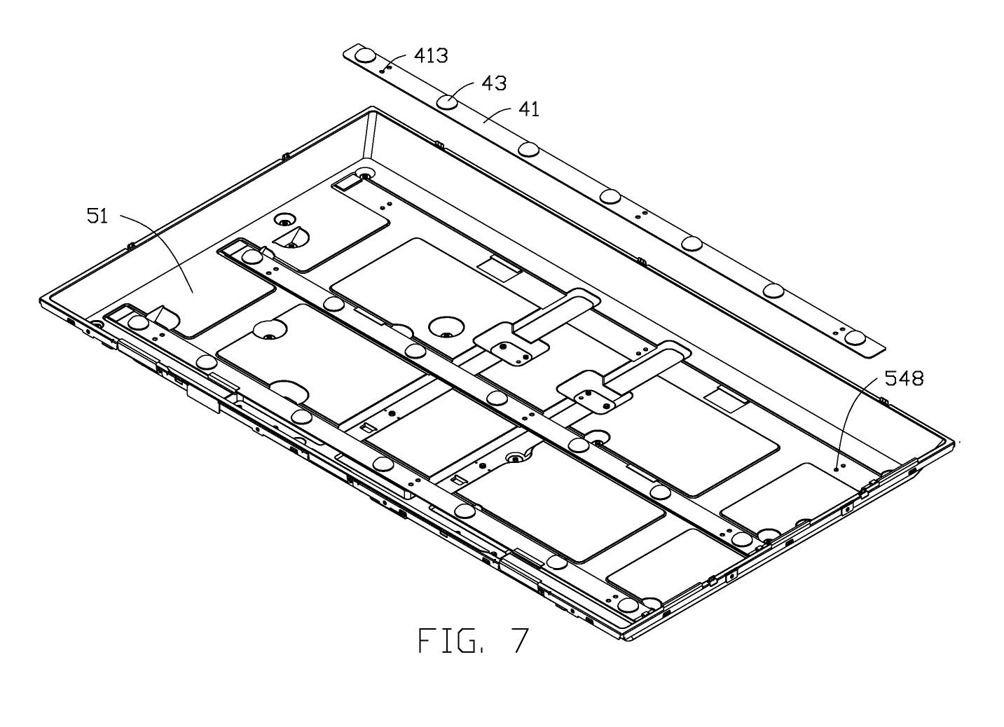

FIG. 7 illustrates a second embodiment of the backlight module 40 and the locating mechanism 54. The PCB 41 defines a plurality of pairs of through holes 413. Each pair of through holes 413 are aligned widthwise. The locating mechanism 54 includes a plurality of pairs of positioning poles 548. Each pair of positioning poles 548 are aligned widthwise.

In use, the light bar 400 is locked on the substrate 51 via the first limiting portion 541, the second limiting portion 544, and the positioning pole 548. Thus, operation convenience increases. Further, the substrate 51 defines the first opening 513 and the second opening 517, and a heat dissipation of the display apparatus 100 is improved.

While various embodiments have been described, the disclosure is not to be limited thereto. Various modifications and similar arrangements (as would be apparent to those skilled in the art) are also intended to fall within this disclosure. The scope of the appended claims should be construed to encompass all such modifications and similar arrangements.

What is claimed is:

1. A backlight module for providing backlight to a display panel, the backlight module comprising:
a substrate;
at least one light bar configured to be coupled to the substrate;
a locating mechanism located on the substrate and configured to lock the at least light bar to the substrate; and
the locating mechanism comprises two opposite first limiting portion, a plurality of second limiting portions, and a plurality of positioning poles;
wherein the second limiting portions and the positioning poles are alternately disposed between the opposite first limiting portions; the first limiting portion, the second limiting portion, and the positioning pole respectively limit the light bar in different directions.

2. The backlight module of claim 1, wherein the first limiting portion limits the at least one light bar in a first direction and a second direction perpendicular to the first direction.

3. The backlight module of claim 2, wherein the first limiting portion comprises a first connecting plate and a first resisting plate; the first connecting plate is extended from the substrate; the first resisting plate is extended from an edge of the first connecting plate away from the substrate; the first connecting plate limits the at least light bar in the first direction, and the first resisting plate limits the at least light bar in the second direction.

4. The backlight module of claim 2, wherein the substrate defines two first openings and a plurality of second openings; the first opening corresponds to the first limiting portion; the first limiting portion upon the first opening completely covers the first opening; the first opening is used for dissipating heat.

5. The backlight module of claim 1, wherein the second limiting portion limits the at least one light bar in the second direction and a third direction perpendicular to the second direction.

6. The backlight module of claim 5, wherein the second limiting portion comprises a second connecting plate and a second resisting plate; the second connecting plate is extended from the substrate; the second resisting plate is extended from an edge of the second connecting plate away from the substrate; the second connecting plate limits the at least light bar in the third direction, and the second resisting plate limits the at least light bar in the second direction.

7. The backlight module of claim 5, wherein the substrate defines a plurality of second openings; the second opening corresponds to the second limiting portion; the second limiting portion upon the second opening partially covers the second opening; the second opening is used for dissipating heat.

8. The backlight module of claim 1, wherein the at least light bar comprises a printed circuit board (PCB) and a plurality of light sources; the PCB defines a plurality of through holes; the through holes correspond to the positioning poles; the positioning pole inserts into the corresponding through hole for limiting the at least one light bar in a plane parallel with the substrate.

9. The backlight module of claim 8, wherein the through hole are straggled with each other.

10. The backlight module of claim 8, wherein the through holes are divided into pairs, each pairs of the through hole are aligned together; the positioning poles are divided into pairs.

11. A display apparatus for displaying images, the display apparatus comprising:
an upper cover;
a lower cover cooperated with the upper cover;
a display panel; and
a backlight module sandwiched between the display panel and the lower cover, and the backlight module configured to provide backlight to the display panel, the backlight module comprising:
a substrate;
at least one light bar configured to be coupled to the substrate;
a locating mechanism located on the substrate configured to lock the at least light bar to the substrate; and
the locating mechanism comprises two opposite first limiting portion, a plurality of second limiting portions, and a plurality of positioning poles;
wherein the second limiting portions and the positioning poles are alternately disposed between the opposite first limiting portions; the first limiting portion, the second limiting portion, and the positioning pole respectively limit the light bar in different directions.

12. The display apparatus of claim 11, the first limiting portion limits the at least one light bar in a first direction and a second direction perpendicular to the first direction.

13. The display apparatus of claim 12, wherein the first limiting portion comprises a first connecting plate and a first resisting plate; the first connecting plate is extended from the substrate; the first resisting plate is extended from an edge of the first connecting plate away from the substrate; the first connecting plate limits the at least light bar in the first direction, and the first resisting plate limits the at least light bar in the second direction.

14. The display apparatus of claim 12, wherein the substrate defines two first openings and a plurality of second openings; the first opening corresponds to the first limiting portion; the first limiting portion upon the first opening completely covers the first opening; the first opening is used for dissipating heat.

15. The display apparatus of claim 11, wherein the second limiting portion limits the at least one light bar in the second direction and a third direction perpendicular to the second direction.

16. The display apparatus of claim 15, wherein the second limiting portion comprises a second connecting plate and a second resisting plate; the second connecting plate is extended from the substrate; the second resisting plate is extended from an edge of the second connecting plate away from the substrate; the second connecting plate limits the at least light bar in the third direction, and the second resisting plate limits the at least light bar in the second direction.

17. The display apparatus of claim 16, wherein the substrate defines a plurality of second openings; the second opening corresponds to the second limiting portion; the second limiting portion upon the second opening partially covers the second opening; the second opening is used for dissipating heat.

18. The display apparatus of claim 11, wherein the at least light bar comprises a printed circuit board (PCB) and a plurality of light sources; the PCB defines a plurality of through holes; the through holes correspond to the positioning poles; the positioning pole inserts into the corresponding through hole for limiting the at least one light bar in a plane parallel with the substrate.

19. The display apparatus of claim 18, wherein the through hole are straggled with each other.

20. The display apparatus of claim 18, wherein the through holes are divided into pairs, each pairs of the through hole are aligned together; the positioning poles are divided into pairs.
